(19) United States
(12) Patent Application Publication
(10) Pub. No.: US 2005/0106943 A1
(43) Pub. Date: May 19, 2005

(54) Combinational USB storage device

(75) Inventor: Charng-Long Lee, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 10/809,359

(22) Filed: Mar. 26, 2004

(30) Foreign Application Priority Data
Nov. 13, 2003 (TW) 092131785

(51) Int. Cl. H01R 24/00

(52) U.S. Cl. 439/630

(57) ABSTRACT

There is provided a combinational USB storage device coupled to an external electronic device for providing a storage capacity to the electronic device. The combinational USB storage device includes an adapter and a storage. The adapter includes a USB connector at one end, the USB connector being adapted to insert into a USB slot of the electronic device, and a first connecting member at the other end. The storage includes at least one memory unit capable of storing data; a second connecting member mated with and coupled to the first connecting member; and a controller electrically coupled to the second connecting member and the memory unit, and electrically coupled to the USB connector via connecting the first connecting member to the second connecting member.

### BACKGROUND OF THE INVENTION

1. Field of the Invention

The present invention relates to a memory card device having a USB interface and, more particularly, to a combinational USB storage device.

2. Description of Related Art

Currently, the trend of electronic products (e.g., notebook computers, palm computers, PDAs (Personal Digital Assistants), digital cameras, etc.) is of lightweight, compact, and portable due to continuous progress in electronics and material science. Such portable product can provide user great convenience particularly in an out-of-office operating environment. Typically, a memory card or portable storage device is adapted to couple to the product for providing an additional storage thereto. For example, a CF (compact flash) card is adapted to insert into a CF slot of digital camera so that the captured digital pictures can be stored in the CF.

Conventionally, a number of different slots are provided in a portable electronic device wherein each of the slots is adapted to couple to a portable storage device (e.g., CF, Smart Media, MM (Multi-Media), or the like) for providing an additional storage thereto. In this design, the storage device can be inserted into an adapted slot only. For example, a CF card can only be inserted into a CF slot of an electronic device. Any other storage device without a CF connector is not allowed to couple to a CF slot of electronic device. Alternatively, any other electronic device without a CF slot is not allowed to couple to a CF card. For solving the problem, a user has to either buy several different portable storage devices so as to be able to use one of various electronic devices or buy another storage device adaptable to the electronic device to be used. Moreover, a user has to buy an additional storage device having a large memory if an available space of the storage device (e.g., memory card) for performing a specific task is not sufficient. This has the drawbacks of increasing unnecessary spending, being harmful to the environment, and being less powerful. Hence, a need for improvement exists.

### SUMMARY OF THE INVENTION

An object of the present invention is to provide a combinational USB storage device for providing an additional storage to a coupled electronic device without having to employ many different memory cards and associated adapters.

Another object of the present invention is to provide a combinational USB storage device, in which different USB connectors can be combined with different storage devices, so as to solve the problem of incompatibility between one of various memory cards and the electronic device, and significantly reduce the spending on buying memory.

In one aspect of the present invention there is provided a combinational USB storage device coupled to an external electronic device for providing a storage capacity to the electronic device. The combinational USB storage device includes: an adapter including a USB connector at one end, the USB connector being adapted to insert into a USB slot of the electronic device, and a first connecting member at the other end; and a storage. The storage includes: at least one memory unit capable of storing data; a second connecting member mated with and coupled to the first connecting member; and a controller electrically coupled to the second connecting member and the memory unit, and electrically coupled to the USB connector via connecting the first connecting member to the second connecting member, thereby either receiving signals from the USB slot and converting the same into digital signals or converting the digital signals into ones adapted to input the USB slot so that the electronic device is able to access data from the memory unit.

In another aspect of the present invention, there is provided a combinational USB storage device coupled to an external electronic device for providing a storage capacity to the electronic device. The combinational USB storage device includes: an adapter including a USB connector at one end, the USB connector being adapted to insert into a USB slot of the electronic device, a first connecting member at the other end, and a controller electrically coupled to the USB connector for receiving signals from the USB slot; and a storage including at least one memory unit capable of storing data, and a second connecting member coupled to the memory unit, and mated with and coupled to the first connecting member, so that the controller is electrically coupled to the memory unit via connecting the first connecting member to the second connecting member, thereby either receiving signals from the USB slot and converting the same into digital signals or converting the digital signals into ones adapted to input the USB slot so that the electronic device is able to access data from the memory unit.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of a first preferred embodiment of combinational USB storage device in accordance with the invention;

FIG. 2 is a perspective view of the USB storage device shown in FIG. 1;

FIG. 3 is a block diagram of a second preferred embodiment of combinational USB storage device in accordance with the invention; and

FIG. 4 is a perspective view of the USB storage device shown in FIG. 3.

### DETAILED DESCRIPTION OF THE PREFERRED EMBODIMENT

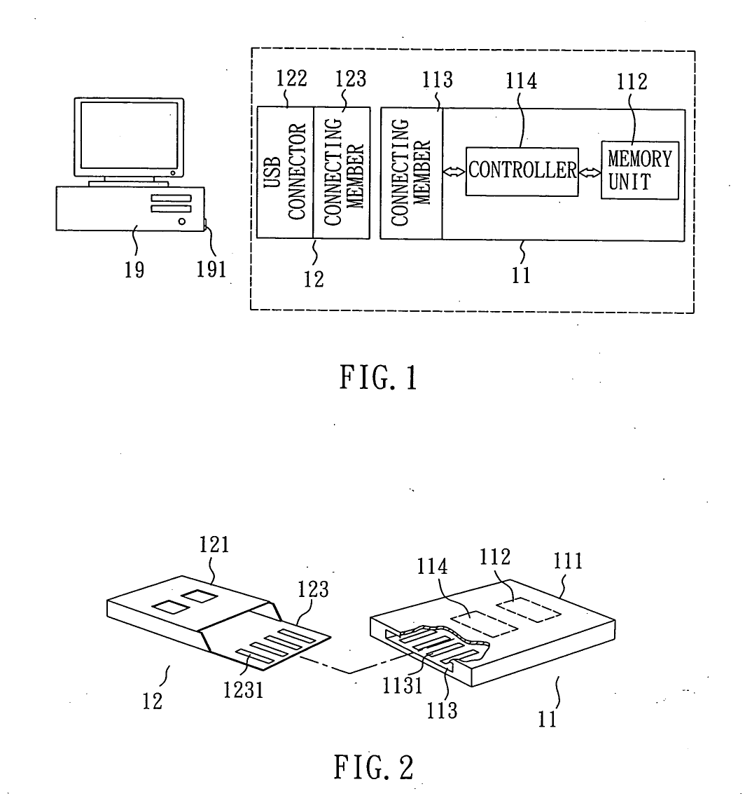

With reference to FIG. 1, there is shown a combinational USB storage device constructed in accordance with a first preferred embodiment of the invention, which comprises a storage 11 and an adapter 12 detachably and electrically coupled to the storage 11. The adapter 12 is adapted to couple to an external electronic device (e.g., computer as shown) 19 so as to provide an additional storage thereto. Each component will be described in detail below.

With reference to FIG. 2, the storage 11 and the adapter 12 are shown. The adapter 12 comprises a USB connector 121 and a first connecting member 123. The USB connector 121 is adapted to insert into a USB slot 191 of the electronic device 19 for electrically connecting thereto. The storage 11 comprises a housing 111 for enclosing at least one memory unit (one is shown) 112 capable of storing data, a second connecting member 113 at one end of the housing 111, and a controller 114 electrically coupled to the second connecting member 113 and the memory unit 112. The second connecting member 113 is adapted to couple to the first connecting member 123 so that the adapter 12 can be detachably and electrically coupled to the storage 11. In the embodiment, the first and second connecting members 123, 113 are mated pin typed connectors. For example, the first connecting member 123 comprises a plurality of metal contacts 1231 and the second connecting member 113 comprises a plurality of corresponding metal contacts 1131 in which a connection of the second and first connecting members 113 and 123 means that the metal contacts 1131 and 1132 are electrically coupled together. Also, the controller 114 is electrically coupled to the USB connector 121 for receiving signals from the USB slot 191. The received signals are then converted into digital ones. On the other hand, digital signals can be converted into ones being adapted to input the USB slot 191 so that the electronic device 19 is able to access data from the memory unit 112. Moreover, both the first and second connecting members 123 and 113 comply with USB in which the metal contacts 1231 of the first connecting member 123 or the metal contacts 1131 of the second connecting member 113 comprise four pins VCC, D+, D−, and GND.

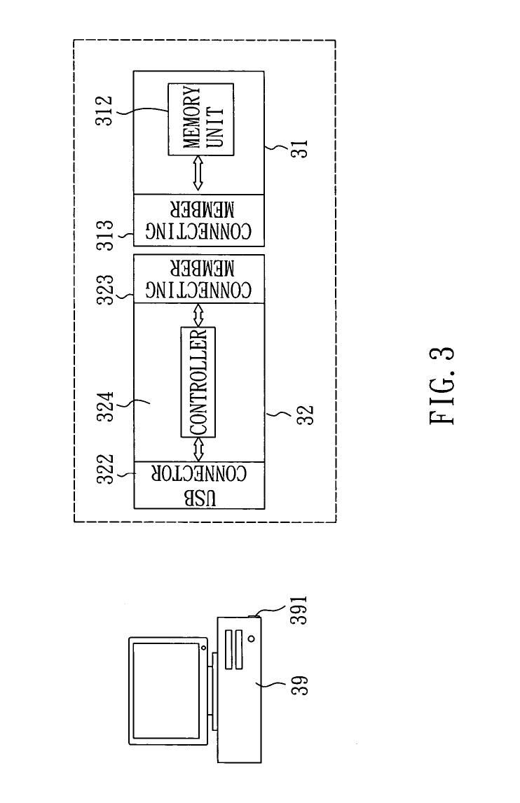

With reference to FIG. 3, there is shown a combinational USB storage device constructed in accordance with a second preferred embodiment of the invention comprising a storage 31 and an adapter 32 detachably and electrically coupled to the storage 31. The adapter 32 is adapted to couple to an external electronic device (e.g., computer as shown) 39 so as to provide an additional storage thereto. Each component will be described in detail below.

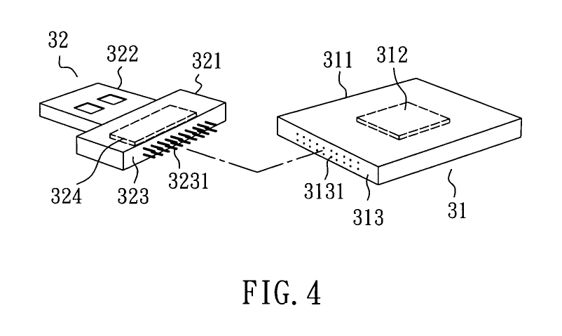

With reference to FIG. 4, the storage 31 and the adapter 32 are shown. The adapter 32 comprises a housing 321, a USB connector 322 projected from one end of the housing 321, the USB connector 322 being adapted to insert into a USB slot 391 of the electronic device 39 for electrically connecting thereto, a third connecting member 323 at the other end of the housing 321, and a controller 324 electrically coupled to the USB connector 322 for receiving signals from the USB slot 391. The storage 31 comprises a housing 311 for enclosing at least one memory unit (one is shown) 312 capable of storing data, and a fourth connecting member 313 at one end of the housing 311, the fourth connecting member 313 being electrically coupled to the memory unit 312 and being mated to the third connecting member 323 so that the adapter 32 can be detachably and electrically coupled to the storage 31. In the embodiment, the third and fourth connecting members 323, 313 are mated pin typed connectors. For example, the third connecting member 323 comprises a plurality of pins 3231 and the fourth connecting member 313 comprises a plurality of corresponding apertures 3131 in which a connection of the third and fourth connecting members 323 and 313 means that the pins 3231 are inserted into the apertures 3131 for electrically connecting thereto. Also, the controller 324 is electrically coupled to the memory unit 312 for receiving signals from the USB slot 391 and converting the same into digital ones. On the other hand, digital signals can be converted into ones being adapted to input the USB slot 391 so that the electronic device 39 is able to access data from the memory unit 312.

The USB connectors 122 and 322 are standard A type connectors in the embodiments, while it is appreciated by those skilled in the art that they can be standard B type connectors, small A type connectors, or small B type connectors without departing from the scope and spirit of the invention. Likewise, the first and second connecting members 123 and 113 in the first embodiment are contacts, and the third and fourth connecting members 323 and 313 in the second embodiment are mated pins and apertures, while it is appreciated by those skilled in the art that the first and second connecting members 123 and 113 can be mated pins and apertures or mated contact and aperture, and the third and fourth connecting members 323 and 313 can be contacts or mated pin and aperture in any other embodiment without departing from the scope and spirit of the invention.

In view of the foregoing, it is known that, in the invention, the adapter is detachably and electrically coupled to the storage. Hence, a user can arbitrarily combine a suitable type of adaptor with storage of various capacities, thereby obtaining a desired USB storage device for being coupled to an electronic device. This can significantly reduce the spending on buying memory. It is known that more and more electronic devices are provided with USB slots. Thus, the USB storage device of the invention is adapted to interconnect, for example, a memory card and the electronic device (e.g., computer). Most importantly, a user owning the combinational USB storage device of the invention means that he/she does not need to buy many different memory cards and associated adapters.

Although the present invention has been explained in relation to its preferred embodiment, it is to be understood that many other possible modifications and variations can be made without departing from the spirit and scope of the invention as hereinafter claimed.

1. A combinational USB storage device coupled to an external electronic device for providing a storage capacity to the electronic device, comprising:
an adapter including a USB connector at one end, the USB connector being adapted to insert into a USB slot of the electronic device, and a first connecting member at the other end; and
a storage including:
at least one memory unit capable of storing data;
a second connecting member mated with and coupled to the first connecting member; and
a controller electrically coupled to the second connecting member and the memory unit, and electrically coupled to the USB connector via connecting the first connecting member to the second connecting member, thereby either receiving signals from the USB slot and converting the same into digital signals or converting the digital signals into ones adapted to input the USB slot so that the electronic device is able to access data from the memory unit.

2. The combinational USB storage device as claimed in claim 1, wherein each of the first and second connecting members complies with USB.

3. The combinational USB storage device as claimed in claim 1, wherein the USB connector is a standard A type connector.

4. The combinational USB storage device as claimed in claim 1, wherein the USB connector is a standard B type connector.

5. The combinational USB storage device as claimed in claim 1, wherein the USB connector is a small A type connector.

6. The combinational USB storage device as claimed in claim 1, wherein the USB connector is a small B type connector.

7. A combinational USB storage device coupled to an external electronic device for providing a storage capacity to the electronic device, comprising:
an adapter including a USB connector at one end, the USB connector being adapted to insert into a USB slot of the electronic device, a first connecting member at the other end, and a controller electrically coupled to the USB connector for receiving signals from the USB slot; and
a storage including at least one memory unit capable of storing data, and a second connecting member coupled to the memory unit, and mated with and coupled to the first connecting member, so that the controller is electrically coupled to the memory unit via connecting the first connecting member to the second connecting member, thereby either receiving signals from the USB slot and converting the same into digital signals or converting the digital signals into ones adapted to input the USB slot so that the electronic device is able to access data from the memory unit.

8. The combinational USB storage device as claimed in claim 7, wherein the USB connector is a standard A type connector.

9. The combinational USB storage device as claimed in claim 7, wherein the USB connector is a standard B type connector.

10. The combinational USB storage device as claimed in claim 7, wherein the USB connector is a small A type connector.

11. The combinational USB storage device as claimed in claim 7, wherein the USB connector is a small B type connector.
